(19) United States
(12) Patent Application Publication
(10) Pub. No.: US 2019/0019522 A1
(43) Pub. Date: Jan. 17, 2019

(54) METHOD AND APPARATUS FOR MULTILINGUAL FILM AND AUDIO DUBBING

(71) Applicant: Dubbydoo, LLC, c/o Fortis LLP, Costa Mesa, CA (US)

(72) Inventor: Juan Bautista Tomas Gabarron, Lorca (ES)

(21) Appl. No.: 16/032,859

(22) Filed: Jul. 11, 2018

Related U.S. Application Data
(60) Provisional application No. 62/531,043, filed on Jul. 11, 2017.

(51) Int. Cl. G10L 19/018; G10L 25/18

(52) U.S. Cl. CPC G10L 19/018; G10L 25/18

(57) ABSTRACT

A method and apparatus for multilingual film and audio dubbing are disclosed. In one embodiment, the method includes dividing an audio file into audio segments, wherein the audio file corresponds to a video file and the audio segments have predetermined time lengths. The method also includes generating fingerprint codes for the audio segments, wherein a fingerprint code is generated for an audio segment and the fingerprint code contains an identity of the video file, a first frequency peak of the audio segment, a time position of the first frequency peak of the audio segment, a second frequency peak of the audio segment, and a time interval between the first frequency peak and the second frequency peak of the audio segment. The method further includes storing the fingerprint codes for the audio segments in a fingerprint codes database.

### CROSS-REFERENCE TO RELATED APPLICATIONS

The present Application claims the benefit of U.S. Provisional Patent Application Ser. No. 62/531,043 filed on Jul. 11, 2017, the entire disclosure of which is incorporated herein in their entirety by reference.

### FIELD

This disclosure generally relates to a method and apparatus for multilingual film and audio dubbing.

### BACKGROUND

Films and TV shows comprise video and audio tracks. Typically, different versions of films and other content may be produced to be shown in different language environments and countries. For example, large budget films may be produced in ten or more different language versions. These different language versions mainly differ in their soundtrack, with substantially the same video component. However, this not always the case as some versions may be edited differently, producing slightly different length films, depending on culture and audience requirements.

Various techniques are used in generating these different language versions. For example, dubbing, i.e. substituting audio in a second language, and the use of subtitles may be used. In dubbing, the original speech may be replaced completely. Other non-speech soundtrack components may remain the same or be replaced as well. The use of subtitles has a disadvantage in placing a strain on a viewer, which may reduce the enjoyment of the production.

There are also systems that provide a form of subtitling and audio in other languages at live performance venues, such as theatres, but these systems may use proprietary hardware, which requires a significant investment by a performance venue and may generally only work within that particular venue. In any case, particular language versions of a film or performance may not be enjoyed to the same extent by people who do not understand that particular language or who have a poor understanding of that language. Providing different language versions of a film on separate screens in a cinema may not be viable if the audience for minority language versions is small. In any case, this approach may not satisfy a group of people who want to see a film together, where they have different first languages (for instance, a husband and wife who were born in different countries). Therefore, there is a general need to provide a method and apparatus that overcomes these problems.

### SUMMARY

A method and apparatus for multilingual film and audio dubbing are disclosed. In one embodiment, the method includes dividing an audio file into audio segments, wherein the audio file corresponds to a video file and the audio segments have predetermined time lengths. The method also includes generating fingerprint codes for the audio segments, wherein a fingerprint code is generated for an audio segment and the fingerprint code contains an identity of the video file, a first frequency peak of the audio segment, a time position of the first frequency peak of the audio segment, a second frequency peak of the audio segment, and a time interval between the first frequency peak and the second frequency peak of the audio segment. The method further includes storing the fingerprint codes for the audio segments in a fingerprint codes database. In addition, the method includes identifying the video file using the fingerprint codes stored in the fingerprint codes database. Furthermore, the method includes offering and enabling selection of alternative audios that are stored in an audio database and that are available for the video file.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a block diagram according to one exemplary embodiment.

FIG. 6 is a flow chart according to one exemplary embodiment.

FIG. 7 is a flow chart according to one exemplary embodiment.

FIG. 8 is a block diagram according to one exemplary embodiment.

FIG. 9 illustrates exemplary audio waveforms according to one exemplary embodiment.

FIGS. 10A and 10B show exemplary sound waves correlations according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP NR (New Radio), 3GPP2 UMB (Ultra Mobile Broadband), WiMax, or some other modulation techniques.

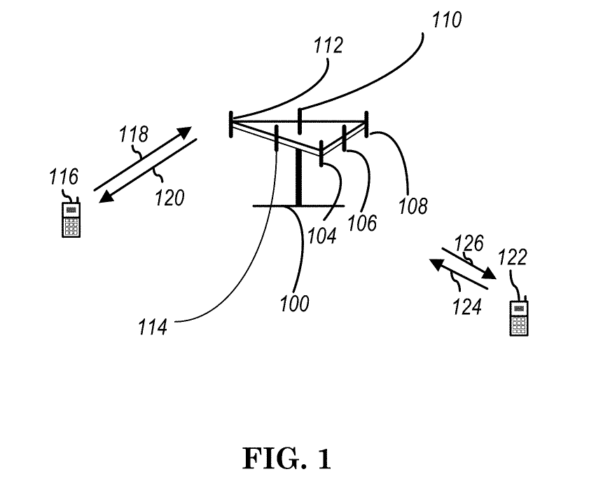

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an evolved Node B (eNB), or some other terminology. An access terminal (AT) may also be called user equipment (UE), a wireless communication device, terminal, access terminal or some other terminology.

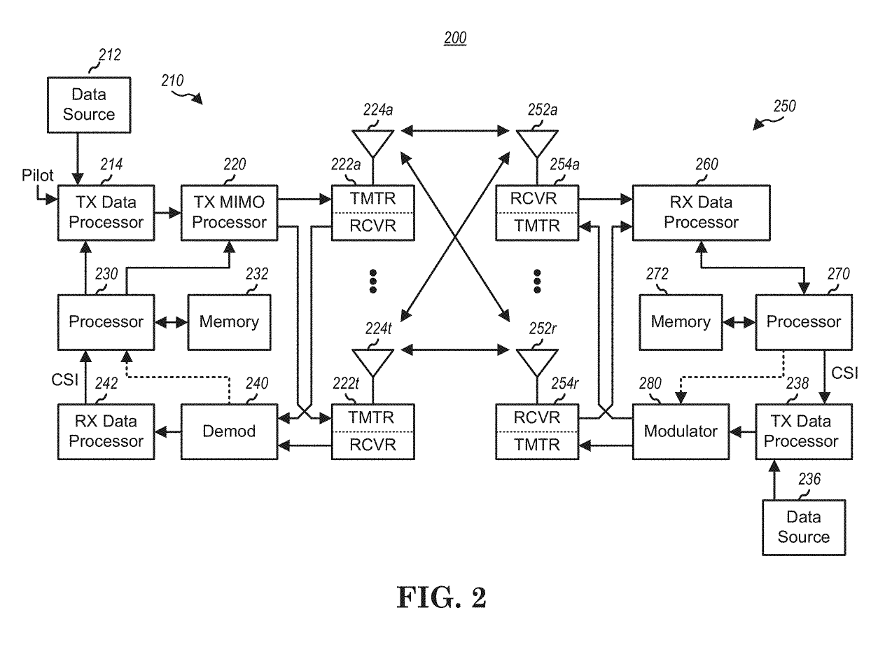

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

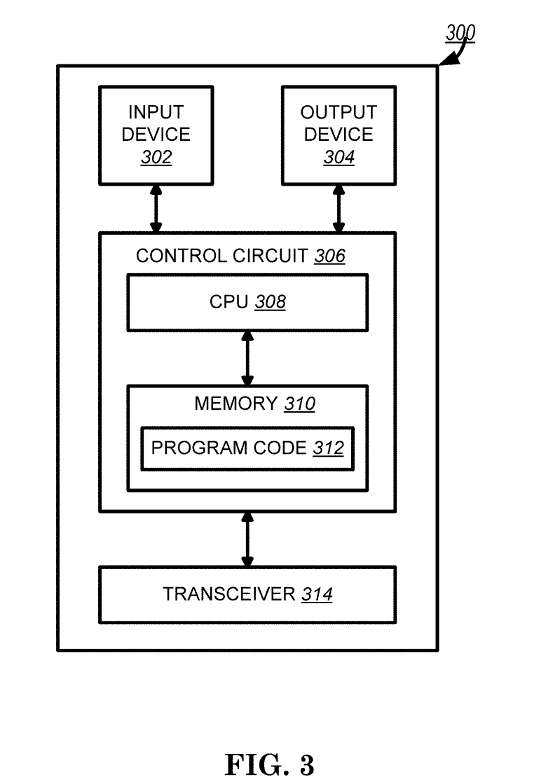

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1 or the base station (or AN) 100 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

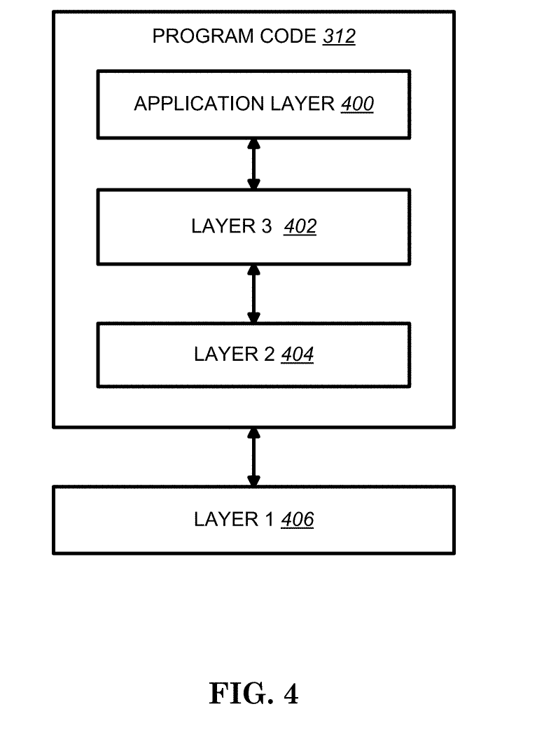

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In one embodiment, the present invention generally includes a smartphone app that allows a user to enjoy any movie or video content, regardless of the format, in the language of the user's choice wherever the user is located. In general, the smartphone app captures a few seconds of audio from a broadcast or a stream, and within a few seconds, provides the user with the available languages for the identified content. After selecting the desired language, the user begins to listen, through his headphones, in synchronization with the movie or video content.

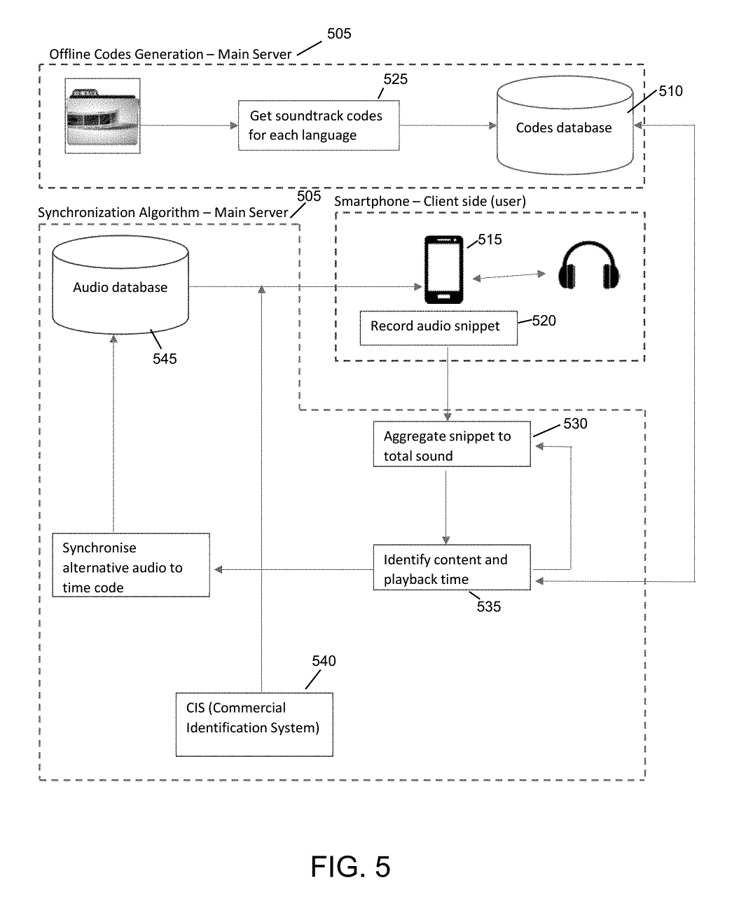

FIG. 5 is a simplified block diagram according to one embodiment of the invention. In one embodiment, the fingerprint codes database 510 in the server 505 is populated with fingerprint codes that correspond to the audios of the movies (or other video contents) in the different languages. The process of generating fingerprint codes could be done offline prior to the synchronization process (which is the main service). Once the fingerprint codes of some specific content are uploaded to fingerprint codes database, they are available in the server 505 for synchronization.

The synchronization process generally includes the smartphone recording an audio snippet 520 of a few seconds of the movie (or other video contents), and sending the recorded audio snippet 520 to the server 505. The server 505 parses (or analyzes) the recorded audio snippet 520 and uses the fingerprint codes stored in the fingerprint codes database 510 to identify the specific movie (or video content) as well as the playback time.

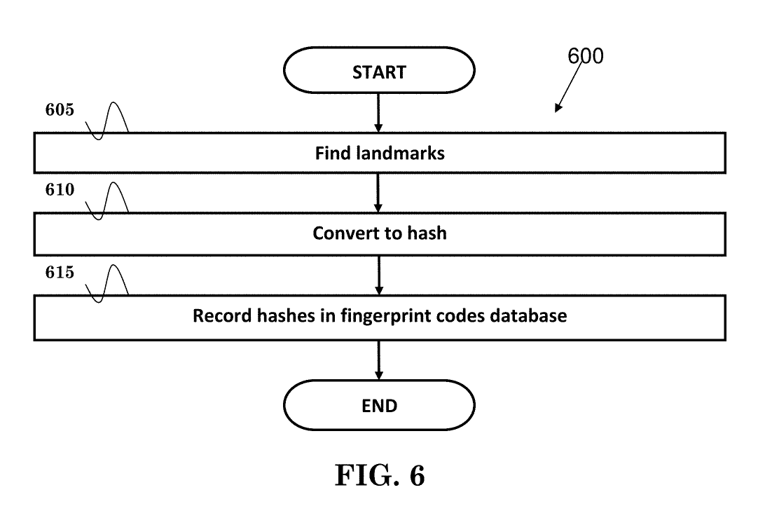

FIG. 6 is a flow chart 600 illustrating the offline process to get soundtrack codes for each language (shown as element 525 of FIG. 5) of movies (or video contents) according to one exemplary embodiment. In general, the offline codes generation process (shown as element 525 of FIG. 5) involves generating fingerprinting codes of the audios (for each language) of the movies, and storing the generated fingerprinting codes in the fingerprint codes database (shown as element 510 of FIG. 5).

Step 605 of FIG. 6 includes finding landmarks of an audio file of a movie (or video content). The input of step 605 is an audio waveform of a move, and the output of step 605 is a four-column matrix (denoted M) containing (t, first_freq, end_freq, delta_time). The process of finding landmarks 605 analyzes, based on specific parameters, the time-frequency pattern of the audio at pre-determined time intervals where pairs of frequency peaks are collected. In one embodiment, the time intervals could be at 5-minute intervals where an audio file is divided into 5-minute audio segments and analyzed accordingly so that pairs of frequency peaks for the 5-minute audio segments are collected. In one embodiment, each pair of frequency peaks corresponds to a row in M (the four-column matrix), which contains a specific time position (denoted t) of the first frequency peak (denoted first_freq), the second frequency peak (denoted end_freq), and the time interval (denoted delta_t) between the first frequency peak (first_freq) and the second frequency peak (end_freq).

Step 610 of FIG. 6 involves converting each individual row of M (the four column matrix) to a pre-hash row P=(id, t, hash_index), where id corresponds to the identity of a movie, t is similar to t in the M matrix, and hash_index is calculated by using a specific hash function for first_freq, end_freq, and delta_time.

Step 615 of FIG. 6 involves (i) calculating the hash from the pre-hash row P, (ii) obtaining the hash vector H=(hash_index, hash), and (iii) storing the hash vector H as a fingerprint code in the fingerprint codes database (shown as element 510 in FIG. 5).

Referring back to FIGS. 3 and 4, in one exemplary embodiment, the device 300 includes a program code 312 stored in the memory 310. The CPU 308 could execute program code 312 to enable the UE (i) to find landmarks of an audio file of a movie (or video content)—as shown in step 605 of FIG. 6, (ii) to convert resulting landmarks of the audio file to a pre-hash row P=(id, t, hash_index)—as shown in step 610 of FIG. 6, and (iii) to calculate the hash from pre-hash row P, obtain the hash vector H=(hash_index, hash), and store the hash vector H as a fingerprint code in the fingerprint codes database—as shown in step 615 of FIG. 6. Furthermore, the CPU 308 can execute the program code 312 to perform all of the above-described actions and steps or others described herein.

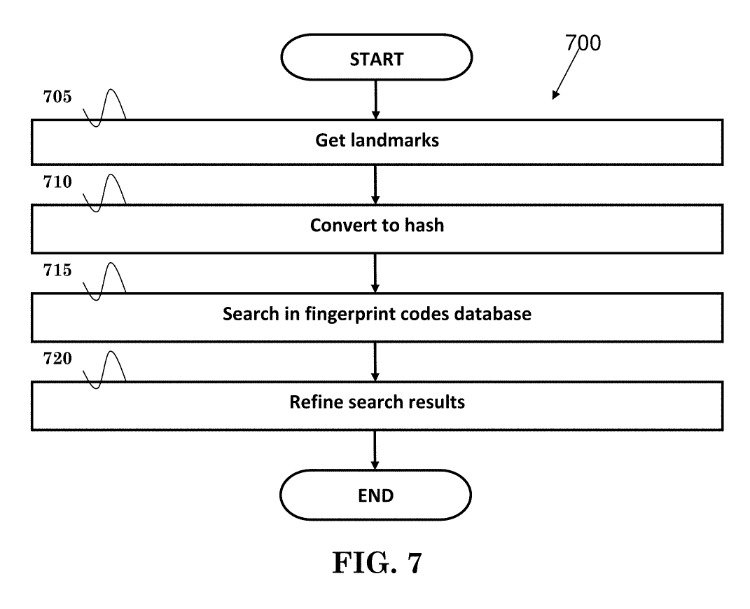

FIG. 7 is a flow chart 700 illustrating the process of identifying content and playback time (shown as element 535 of FIG. 5) according to one exemplary embodiment. As shown in FIG. 5, the audio that the smartphone 515 records in step 520 is incrementally added or aggregated in step 530. For example, an audio snippet could be sent every few seconds (e.g. 2 seconds in one embodiment), and is added to the already combined audio, as shown in step 530 of FIG. 5. Then the process of identifying content and playback time consists of trying to identify, from the audio snippet, the specific movie (or video content) as well as the playback time at the beginning of the snippet (denoted t) that corresponds to the movie represented by the identification number (denoted id).

Step 705 of FIG. 7 involves getting the landmarks from the audio snippet(s) recorded and sent from the smartphone. The process of getting landmarks 705 is somewhat similar to the process of finding landmarks (shown as element 605 in FIG. 6). In one embodiment, one change is that in getting landmarks 705, there is a higher density of peaks to be found in order to maximize the probability to get the corresponding fingerprints that match with the specific movie.

Step 710 of FIG. 7 involves converting each individual row of a four-column matrix M to a pre-hash row P=(id, t, hash_index), where id corresponds to the identity of the movie, t is similar to t in the M matrix, and hash_index is calculated by using a specific hash function for first_freq, end_freq, and delta_time.

Step 715 of FIG. 7 involves searching the fingerprint codes database 510 for matches of the set of hashes generated from the audio snippet(s) in step 710. If a match of hash value is found, the id and the playback time (denoted t) of the specific movie (or video content) could be obtained from the matched hash value.

Step 720 of FIG. 7 involves refining results found in step 715. In step 720, irrelevant results are removed while the most important rows of M are kept to improve processing performance. In one embodiment, the results returned is a matrix with 4 columns (id, index_quality, temporal_reference, temporal_reference_2), where id identifies the movie (or video content), index_quality represents the selection of the one with the highest number of fingerprint matches, temporal_reference represents the time point in the movie when the audio snippet taken by the smartphone began, and temporal_reference_2 represents the time point inside the block of audio where the snippet fell.

Referring back to FIGS. 3 and 4, in one exemplary embodiment, the device 300 includes a program code 312 stored in the memory 310. The CPU 308 could execute program code 312 (i) to getting the landmarks from the audio snippet(s) recorded and sent from the smartphone—shown in step 705 of FIG. 7, (ii) to convert resulting landmarks of the audio file to a pre-hash row P=(id, t, hash_index)—shown in step 710 of FIG. 7, (iii) to search the fingerprint codes database 510 for matches of the set of hashes generated from the audio snippet(s)—shown in step 715 of FIG. 7, and (iv) to refine results found—shown in step 720 of FIG. 7. Furthermore, the CPU 308 can execute the program code 312 to perform all of the above-described actions and steps or others described herein.

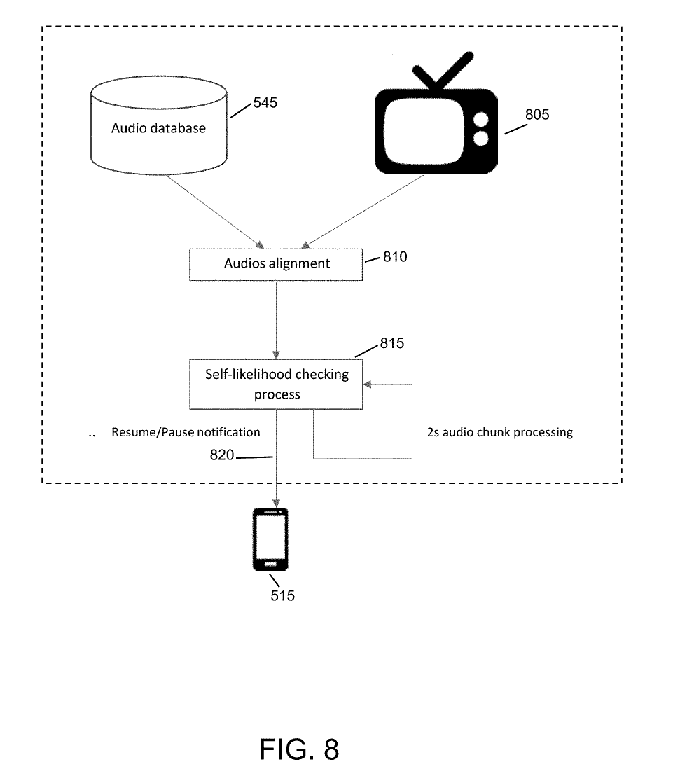

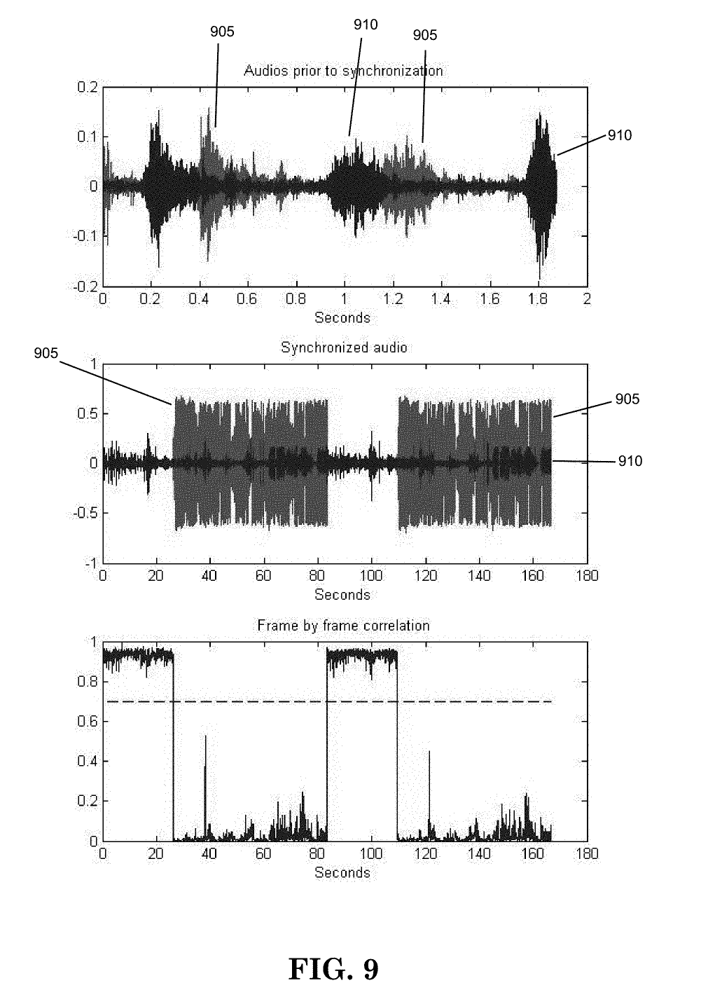

FIG. 5 includes a commercial identification system (CIS) 540. FIG. 8 is a block diagram of a CIS according to one exemplary embodiment. In one embodiment, the CIS generally works in two steps. First, the CIS has a trigger that whenever a movie starts according to schedule (e.g. from television), the system aligns (step 810) the audio captured (i.e. from television with advertising shown as red waves 905 in FIG. 9) with the corresponding audio (i.e. pure audio, with no ads, shown as blue waves 910 in FIG. 9) from the audio database 545. In one embodiment, a period no longer than 2 seconds is taken from the audios in audio database 545, and aligned with the audio captured from the television. The audio from television is captured or recorded at a sample frequency of 48 KHz (i.e. 2 seconds correspond to 96,000 audio samples).

Once the alignment occurs, the CIS continuously captures sound from the movie on TV in 2-second chunks. As shown in FIG. 9, both red waves 905 and blue waves 910 overlap during the first 23 seconds, and are therefore equal in shape. By comparing (step 815 of FIG. 9) each captured 2-second audio chunk (with ads) with the corresponding 2-second audio snippet (pure audio without ads) in the audio database 545, it would be possible to identify when a commercial starts (as depicted by overlapping red waves 905 and blue waves 910 in FIG. 9). This identification and comparison process divides the chunks in frames, N samples long (for example, N=2048 samples).

In one embodiment, there is a jump factor, denoted H (for instance, H=1024 that accounts for frame overlapping when executing the process). Then, the CIS takes N samples for the corresponding frame of each chunk, advancing with an offset of H samples. For each couple of frames, normalized cross-correlation is calculated. Cross-correlation would be approximately equal or close to 1 when both frames correspond to the same portion of audio. However, cross-correlation would be less than 1 when the frames are different (as shown in the third graph of FIG. 9 for example).

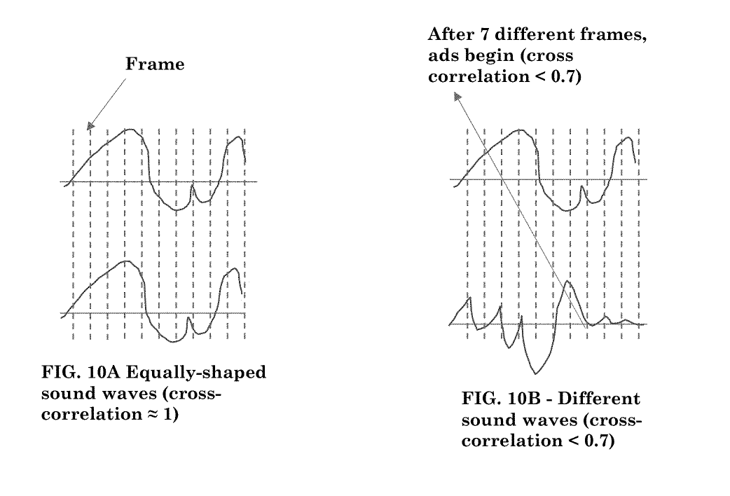

FIG. 10A shows an example where the audios from the television and from the audio database 545 are the same. As shown in FIG. 10A, since the audios from television and from the audio database 545 are exactly the same when no ads appear, normalized cross-correlation equals to 1. However, when this does not happen, the CIS will consider that if at least 7 consecutive frames with a cross-correlation below threshold (of 0.7 for example) occur, then there is a commercial.

FIG. 10B illustrates an example where the audios from the television and from the audio database are different. In this case, the CIS would pick the sample location in the timeline of the first frame; and the CIS would then send a notification to the user smartphone, which would automatically pause the streaming. When commercial block ends, the cross-correlation gets values over the threshold for each couple of frames processed. If at least 7 consecutive frames have a value over the threshold, the CIS would consider the commercials had ended. The CIS would notify (step 820 of FIG. 8) the smartphone, giving information on the sample corresponding to the first frame that overcame the threshold. The smartphone could automatically resume the audio, based on to the notification, in synchronization with the content from television.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A method for providing alternative audio for combined video and audio content, comprising:
dividing an audio file into audio segments, wherein the audio file corresponds to a video file and the audio segments have predetermined time lengths;
generating fingerprint codes for the audio segments, wherein a fingerprint code is generated for an audio segment and the fingerprint code contains an identity of the video file, a first frequency peak of the audio segment, a time position of the first frequency peak of the audio segment, a second frequency peak of the audio segment, and a time interval between the first frequency peak and the second frequency peak of the audio segment;
storing the fingerprint codes for the audio segments in a fingerprint codes database;
identifying the video file using the fingerprint codes stored in the fingerprint codes database; and
offering and enabling selection of alternative audios that are stored in an audio database and that are available for the video file.

2. The method of claim 1, wherein the fingerprint code generated for the audio segment contains a hash of the identity of the video file, the first frequency peak of the audio segment, the time position of the first frequency peak, the second frequency peak of the audio segment, and the time interval between the first frequency peak and the second frequency peak.

3. The method of claim 1, wherein the time position of the first frequency peak contained in the fingerprint code is used as a playback time of an alternative audio after the alternative audio is selected.

4. The method of claim 1, further comprising:
capturing audio snippets of a streamed or broadcasted combined video and audio content;
generating snippet codes for the captured audio snippets, wherein a snippet code is generated for a captured audio snippet and the snippet code contains an identity of the streamed or broadcasted combined video and audio content, a first frequency peak of the captured audio snippet, a time position of the first frequency peak of the captured audio snippet, a second frequency peak of the captured audio snippet, and a time interval between the first frequency peak and the second frequency peak of the captured audio snippet; and
identifying the video file by matching the snippet codes to the fingerprint codes stored in the fingerprint codes database, wherein the video file is identified when a match occurs.

5. The method of claim 4, wherein the snippet code generated for the captured audio snippet contains a hash of the identity of the video file, the first frequency peak of the captured audio snippet, the time position of the first frequency peak the captured audio snippet, the second frequency peak of the captured audio snippet, and the time interval between the first frequency peak and the second frequency peak the captured audio snippet.

6. The method of claim 4, wherein the time position of the first frequency peak of the captured audio snippet contained in the snippet code is used as a playback time of an alternative audio after the alternative audio is selected.

7. A server for providing alternative audio for combined video and audio content, comprising:
a control circuit;
a processor installed in the control circuit; and
a memory installed in the control circuit and operatively coupled to the processor;
wherein the processor is configured to execute a program code stored in the memory to:
divide an audio file into audio segments, wherein the audio file corresponds to a video file and the audio segments have predetermined time lengths;
generate fingerprint codes for the audio segments, wherein a fingerprint code is generated for an audio segment and the fingerprint code contains an identification of the video file, a first frequency peak of the audio segment, a time position of the first frequency peak, a second frequency peak of the audio segment, and a time interval between the first frequency peak and the second frequency peak;
store the fingerprint codes for the audio segments in a fingerprint codes database;
identify the video file using the fingerprint codes stored in the fingerprint codes database; and
offer and enable selection of alternative audios that are stored in an audio database and that are available for the video file.

8. The server of claim 7, wherein the fingerprint code generated for the audio segment contains a hash of the identity of the video file, the first frequency peak of the audio segment, the time position of the first frequency peak, the second frequency peak of the audio segment, and the time interval between the first frequency peak and the second frequency peak.

9. The server of claim 7, wherein the time position of the first frequency peak contained in the fingerprint code is used as a playback time of an alternative audio after the alternative audio is selected.

10. A communication device for providing alternative audio for combined video and audio content, comprising:
a control circuit;
a processor installed in the control circuit; and
a memory installed in the control circuit and operatively coupled to the processor;
wherein the processor is configured to execute a program code stored in the memory to:
capture audio snippets of a streamed or broadcasted combined video and audio content;
generate snippet codes for the captured audio snippets, wherein a snippet code is generated for a captured audio snippet and the snippet code contains an identity of the streamed or broadcasted combined video and audio content, a first frequency peak of the captured audio snippet, a time position of the first frequency peak of the captured audio snippet, a second frequency peak of the captured audio snippet, and a time interval between the first frequency peak and the second frequency peak of the captured audio snippet; and
identify a video file by matching the snippet codes to the fingerprint codes stored in a fingerprint codes database, wherein the video file is identified when a match occurs.

11. The communication device of claim 10, wherein the snippet code generated for the captured audio snippet contains a hash of the identity of the video file, the first frequency peak of the captured audio snippet, the time position of the first frequency peak the captured audio snippet, the second frequency peak of the captured audio snippet, and the time interval between the first frequency peak and the second frequency peak the captured audio snippet.

12. The communication device of claim 10, wherein the time position of the first frequency peak of the captured audio snippet contained in the snippet code is used as a playback time of an alternative audio after the alternative audio is selected.
